(19) United States
(12) Patent Application Publication
(10) Pub. No.: US 2010/0198428 A1
(43) Pub. Date: Aug. 5, 2010

(54) MULTI-PURPOSE FOB SYSTEM

(75) Inventors: Michel F. Sultan, Troy, MI (US); Dale L. Partin, Ray Township, MI (US); Craig A. Tieman, Westfield, IN (US); Todd P. Oman, Greentown, IN (US)

Correspondence Address: DELPHI TECHNOLOGIES, INC;LEGAL STAFF - M/C 483-400-402, 5725 DELPHI DRIVE, PO BOX 5052, TROY, MI, 48007, US

(73) Assignee: DELPHI TECHNOLOGIES, INC., Troy, MI (US)

(21) Appl. No.: 12/362,629

(22) Filed: Jan. 30, 2009

(51) Int. Cl. G06F 19/00; G01S 1/00

(52) U.S. Cl. 701/2; 342/357.09

(57) ABSTRACT

A wireless device is provided having an integrated vehicle fob and entertainment functionality. The wireless device includes a vehicle fob transponder for providing signals to a vehicle for at least one of remote keyless entry, passive entry, passive start, and immobilization functions. The wireless device also includes one or more entertainment receivers for providing entertainment and information functionality on board the vehicle. A controller controls the vehicle fob transponder and the entertainment receivers. One or more communication links are provided for communicating between the wireless device and a vehicle to provide vehicle fob functionality and entertainment and information functionality.

### TECHNICAL FIELD

The present invention generally relates to vehicle entertainment and fob controls, and more particularly relates to vehicle fob and entertainment functionality integration on board the vehicle.

### BACKGROUND OF THE INVENTION

Automotive vehicles commonly employ car radios, navigation systems, and other entertainment and information devices installed on board the vehicle. These devices frequently include receivers integrated into the vehicle along with antennas for receiving signals such as AM/FM and satellite audio signals in addition to GPS signals. In addition, the vehicle is often controlled with a vehicle fob that allows a user to control remote passive entry of doors and trunk, remote start/stop functions, panic on/off alerts, intrusion alerts, close passenger door windows, and display static vehicle parameters remotely. The fob may be used to unlock a vehicle using “remote keyless entry” in which the user presses a button on the fob that causes one or more doors to unlock, or “passive entry” in which close proximity of the fob to the vehicle is automatically sensed, and then a vehicle door automatically unlocks when the user reaches out a hand to the door handle to open it. The vehicle fob is portable and may be easily transported on board and off board the vehicle.

The installation of the entertainment receivers and other receivers on board the vehicle generally makes it difficult to upgrade or replace such devices to meet the specific needs of the user. Additionally, with the proliferation of portable electronic devices such as iPods and portable radio receivers, users may choose to use alternative entertainment devices on board the vehicle. Further, with an increased demand for low cost vehicles, there may be a need to eliminate the duplication of such functionality.

It is therefore desirable to provide for vehicle electronics that may integrate vehicle functionality so as to avoid duplication and provide a cost effective vehicle for consumers.

### SUMMARY OF THE INVENTION

According to one aspect of the present invention, a wireless device having integrated vehicle fob and entertainment functions is provided. The device comprises a vehicle fob transponder for providing signals to a vehicle for at least one of remote keyless entry, passive entry, passive start, and immobilization. The device also includes an entertainment receiver providing at least audio radio reception, a controller for controlling the vehicle fob transponder and the entertainment receiver, and a communication link for communicating with a vehicle.

According to another aspect of the present invention, a vehicle is provided which comprises an audio speaker system for broadcasting audio sound to one or more passengers in the vehicle and an amplifier coupled to the speaker system. The vehicle also includes a docking station for receiving a wireless device and a wireless device adapted to engage the docking station. The wireless device comprises an entertainment receiver providing at least audio signals for amplification and broadcast on the speaker system, and further provides vehicle fob functionality.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a schematic block diagram illustrating a wireless multi-purpose fob used on board a vehicle, according to one embodiment;

FIG. 2 is a schematic diagram of a docking station employed in the vehicle to receive the multi-purpose fob, according to one embodiment;

FIG. 3 is a block diagram illustrating the electronics on board the vehicle associated with the vehicle information module, according to one embodiment; and

FIG. 4 is a block diagram illustrating the electronics associated with the multi-purpose fob, according to one embodiment.

### DESCRIPTION OF THE PREFERRED EMBODIMENT

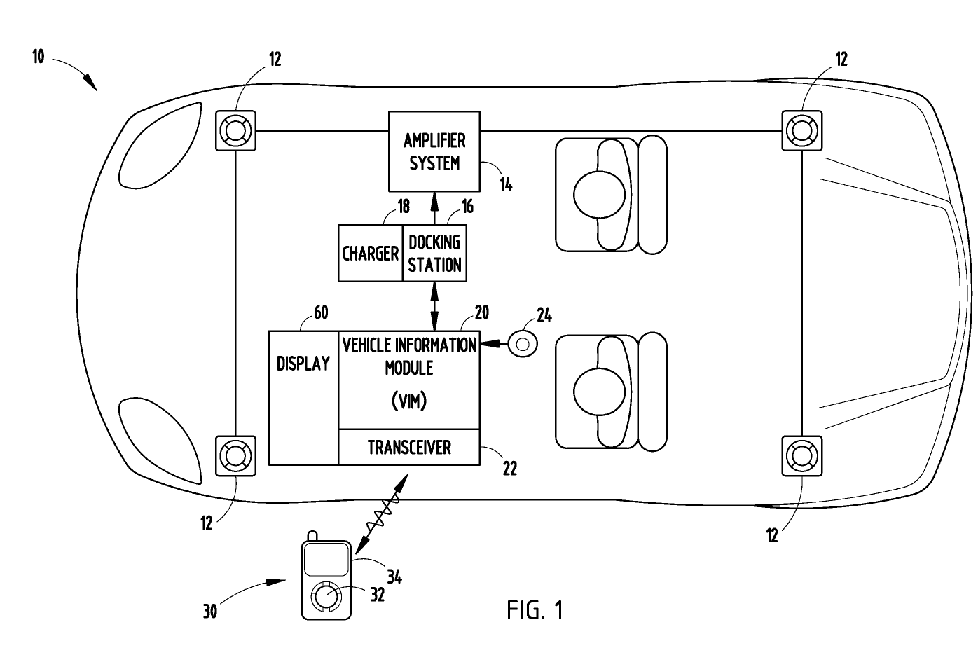

Referring now to FIG. 1, an automotive vehicle 10 is generally illustrated configured to communicate with a wireless device 30, shown and described herein as a multi-purpose fob, according to one embodiment. The vehicle 10 may include an automotive vehicle having an internal combustion engine and road wheels, such as a passenger car or truck, according to one embodiment. It should be appreciated that the vehicle 10 may include other kinds of vehicles.

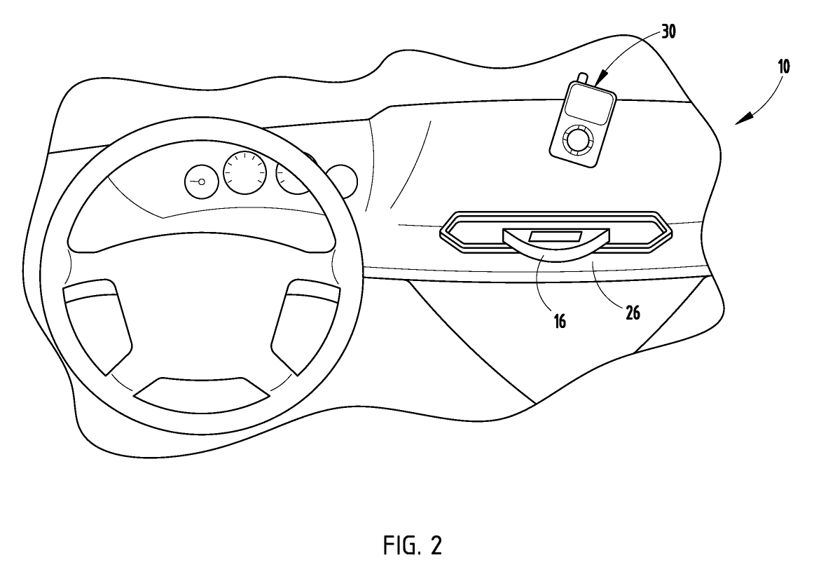

The vehicle 10 is shown having an audio system in the form of a plurality of audio speakers 12 and an amplifier system 14. The audio speakers 12 and amplifier system 14 amplify and broadcast audio sound to passengers within the passenger compartment of the vehicle 10. The vehicle 10 also includes a docking station 16 adapted to receive the wireless device 30 when used in the vehicle 10. Also shown incorporated in the docking station 16 is a charger 18 for charging the wireless fob device 30. The docking station 16 is shown in FIG. 2 installed in the dashboard 26 of the vehicle 10 in close proximity to and accessible by the user (e.g., driver) of the vehicle 10. However, it should be appreciated that the docking station 16 may be located at other locations within the passenger compartment of the vehicle 10 that allow a driver and/or passengers to access the wireless device 30. The vehicle 10 further includes a vehicle information module (VIM) 20 which is shown coupled to a transceiver 22 and a display 60. The VIM is the main controller that manages the human machine interface (HMI) system between the driver and the vehicle systems. The HMI system includes a multi-functional switch 24 and a reconfigurable display according to one embodiment.

The vehicle 10 shown and described herein is configured without entertainment receivers such as the AM and FM radio receiver, satellite audio receiver, and GPS receiver conventionally installed into the vehicle 10. Instead, the wireless device 30 includes the various entertainment and information receivers. The wireless device 30 provides the audio entertainment and information signals to the VIM 20 and amplifier system 14 which amplifies the audio sound and transmits it to the speakers 12 for broadcast to passengers in the vehicle 10. By eliminating the need for the entertainment and information receivers and other electronics to be built into or otherwise fixedly installed in the vehicle 10, more options for user specific receivers may be employed on board the vehicle 10 integrated within the wireless device 30.

Referring to FIG. 2, the wireless device 30 and its docking station 16 are illustrated, according to one embodiment. The docking station 16 is shown mounted in the dashboard 26 generally forward of the driver of the vehicle 10 at a location that allows the driver to insert the wireless device 30 into the docking station 16 and remove the wireless device 30 from the docking station. The wireless device 30 serves both as a vehicle fob to provide the vehicle fob functionality and also serves as an entertainment and information device to provide entertainment and information functionality useful both on the vehicle 10 and off the vehicle 10. The docking station 16 may include electrical contacts for engaging contacts on the wireless device 30 so as to provide a wired connection to communicate electrical signals therebetween. Alternately, the wireless device 30 may be configured with wireless communication such as Bluetooth® or 802.11 to communicate the signals between the wireless device 30 and the vehicle 10. Additionally, the docking station 16 is configured with a charger 18 that allows the wireless device 30 to be recharged such that a rechargeable battery within the wireless device 30 receives electrical power to recharge the battery. According to one embodiment, the charger 18 includes an inductive charger that provides inductive charging of the battery by way of inductive coils. According to another embodiment, the charger 18 may employ an electrical wired connection for supplying electrical power from a battery of the vehicle 10 to the rechargeable battery within the wireless device 30.

The multi-purpose wireless device 30 integrates the vehicle fob, the audio radio (AM, FM, XM), music players (e.g., MP3), memory, and potentially other functions into a single portable device that is usable both on board the vehicle 10 and off the vehicle 10. For example, when used at home, the multi-purpose wireless device 30 may operate as a nomadic multi-media device that provides multi-media information to a user through ear phones or when plugged into a docking station/audio system. Additionally, the wireless device 30 can be interfaced to a computer to download multi-media files, manipulate audio playlists, and transfer data files including vehicle driver or other passenger preferences. When the multi-purpose fob 30 is used within a specified range of the vehicle 10, the wireless device 30 may also communicate via wireless communication with the vehicle 10 and control various functions on board the vehicle 10. Inside the vehicle, the multi-purpose wireless device 30 may plug into and be connected to the docking station 16, which links the wireless device 30 to HMI system (e.g., VIM 20, switch 24, and display 60), the charger 18, and the stereo system which includes the amplifier system 14 and speakers 12. The user may interact with the HMI system to control the multi-purpose wireless device 30 and its multi-media and other functions.

The wireless device 30 is shown having a housing that generally contains and houses the receivers, antennas, communication circuitry and all the various other components. The wireless device 30 has a reconfigurable display 34 and user input controls implemented as a multi-function switch 32 which allows a user to interface with the wireless device 30. The reconfigurable display 34 may include touch screen buttons that will allow user inputs of data and commands. Additionally, the wireless device 30 has a controller and other various features as described herein.

The multi-purpose vehicle fob 30 provides vehicle fob functionality which includes remote/passive entry of vehicle doors and trunk, remote engine start/stop functions, push button start/stop functions, panic on/off functions, intrusion alert functions, display of static vehicle parameters remotely (e.g., door locks, tire pressure, fuel, etc.), and close window functions. The wireless device 30 also provides entertainment and information functionality which, according to one embodiment, includes the display of real-time vehicle parameters that include replacing the cluster functions such as speedometer, tachometer, oil pressure, diagnostics, and other potential functionality. The information and entertainment functionality also includes emergency assist request via the fob instead of an alternative vehicle module (e.g., OnStar®). The information and entertainment functionality further includes control of vehicle systems such as those that may replace the center stack controls including at least one of radio, HVAC, and navigation functions, etc., and control various vehicle functions to replace general controls such as those that control the windows, mirrors, oil life reset, and trip odometer. The information and entertainment functionality may further include storing and downloading preferences for multiple drivers or users of the vehicle, mobile phone functions that provide hands free operation when used in the vehicle, navigation functions that may replace the center stack unit, and internet connectivity. Additionally, the wireless device 30 includes entertainment and information receivers that provide entertainment and other information including the AM/FM receivers, satellite audio receivers, EVDO receivers, 3G receivers, and other entertainment receiver devices. Further, the information and entertainment functionality may include entertainment data and functionality stored in the fob memory and routed to the vehicles entertainment system and may further include a camera for personalization and security purposes.

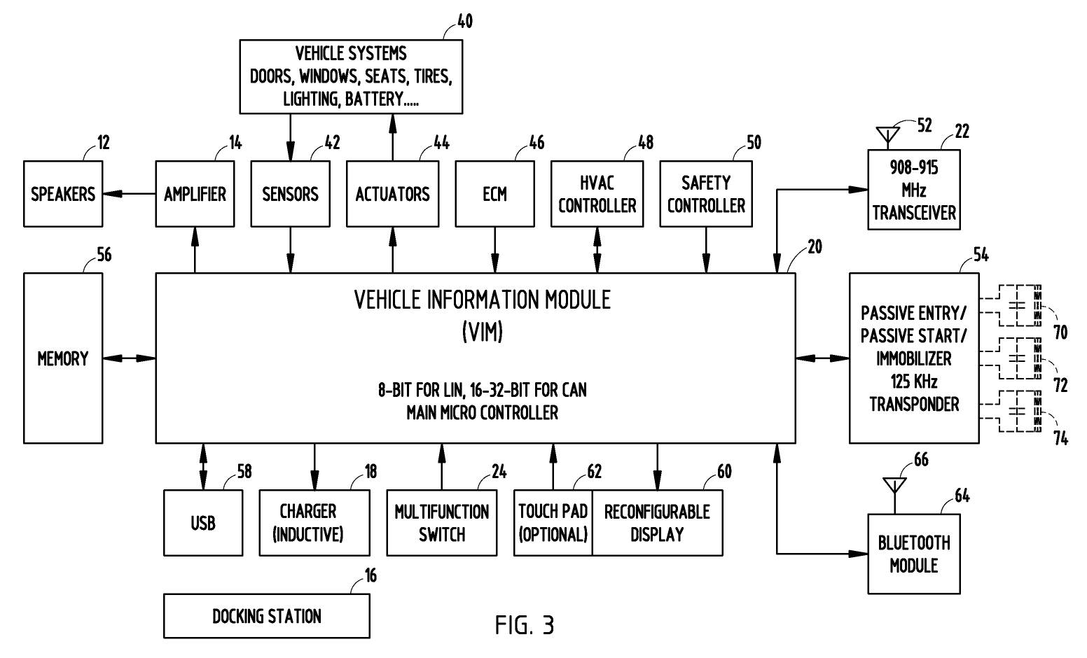

Various features installed on the vehicle 10 that may operate in conjunction with the wireless device 30 are illustrated in FIG. 3, including the VIM 20 and components associated therewith. The VIM 20 essentially operates as a microcontroller for controlling various functions on board the vehicle 10. According to one embodiment, the microcontroller 20 includes a microprocessor and may have 8-bits for LIN, 16-32 bits for CAN. The VIM 20 is shown communicating with various devices installed on board the vehicle 10 including the amplifier 14, sensors 42, actuators 44, engine control module (ECM) 46, the heating ventilation and cooling (HVAC) controller 48, and the safety controller 50. The sensors 42 may sense parameters of various vehicle systems 40 including doors, windows, seats, tires, lighting, and the battery, amongst other vehicle systems. The actuators 44 may actuate such devices of the vehicle system 40. The VIM 20 also communicates with a transceiver 22, shown as a 908-915 MHz transceiver that may transmit and receive signals via antenna 52. The transceiver 22 operates as a long distance, bidirectional communication link to communicate with the wireless multi-purpose fob 30. For example, the multi-purpose fob 30 may be used in a remote keyless entry mode to input a command that is sent to the vehicle and received via the 908-915 MHz antenna 52, causing one or more vehicle doors 40 to unlock.

The VIM 20 also communicates with the passive entry/passive start/immobilizer transponder 54. The transponder 54 as shown is a 125 kHz transponder, according to one embodiment. The transponder 54 provides close range (e.g., within one or two meters) communication with the multi-purpose fob 30. This may be achieved using close range antennas 70, 72 and 74 for providing signals that correspond to the respective passive entry, passive start, and immobilizer functions. The VIM 20 further communicates with a Bluetooth® module 64 for providing wireless signal communication with various devices inside the vehicle, including the multi-purpose fob 30. Bluetooth® is a generally short range wireless communication link. However, it should be appreciated that other short and long range wireless communication links may be employed.

The VIM 20 further is shown coupled to a reconfigurable display 60 that allows for the visual display of information viewable to passengers in the vehicle 10. The reconfigurable display 60 may include a touch pad that further allows user input of data and commands. A multi-function switch 24 is provided in the vehicle 10 and serves as a human machine interface (HMI) to allow a user in the vehicle 10 to select the functionality desired by the user. For example, the switch 24 may select amongst a plurality of available entertainment and information functions. The VIM 20 further communicates with a universal serial bus (USB) 58 that allows data communication between the VIM 20 and the wireless device 30 through the docking station 16. The charger 18 is shown as part of or in close proximity to the docking station 16 and may employ an inductive charger coil that may be coupled to a charging coil within the wireless device 30 to provide inductive charging of the rechargeable battery powering the wireless device 30.

The VIM 20 is further shown coupled to memory 56. Memory 56 may include volatile or non-volatile memory including random access memory (RAM), electronically erasable programmable read-only memory (EEPROM), flash memory, and other known memory storage mediums for storing data. Memory 56 may store data downloaded from the wireless device 30.

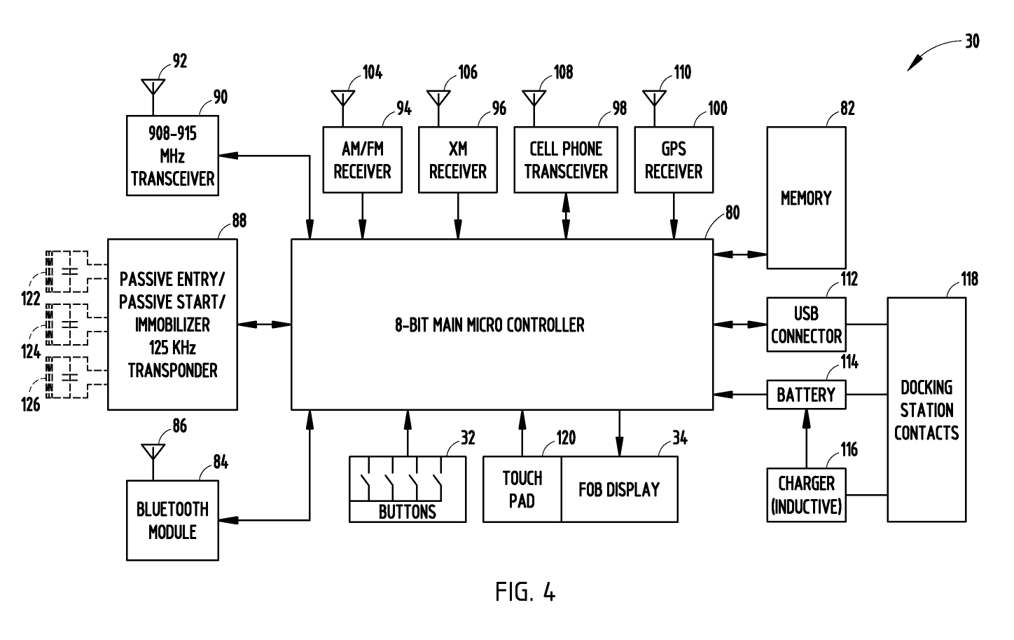

The wireless device 30 is illustrated further in FIG. 4 having a microcontroller 80 coupled to the fob display 34 and user input buttons 32. The fob display 34 may include a touch pad 120 that allows further user input. The wireless device 30 also includes a transceiver 90, shown according to one example as a 908-915 MHz transceiver that transmits and receives signals, which enables communication with the transceiver 22 on board the vehicle 10. The wireless device 30 also includes a passive entry/passive start/immobilizer transponder 88, shown as a 125 kHz transponder. The transponder 88 is shown having antennas 122, 124, and 126 for providing close by communication with the vehicle 10 to transmit the respective passive entry, passive start, and immobilizer function signals to the transponder antennas 70, 72, and 74 on the vehicle 10. Accordingly, the transponder 88 enables the multi-purpose fob 30 to provide vehicle fob functionality communicated to the vehicle 10.

The wireless device 30 further includes a plurality of receivers which are integrated within the wireless device 30 instead of being installed on the vehicle. The receivers include an AM/FM receiver 94 having an antenna 104, and a satellite receiver, such as an XM receiver 96 having an antenna 106. Additionally, a GPS receiver 100 having antenna 110 is shown provided in the wireless device 30. The GPS receiver 100 receives global system signals and provides accurate location information that is useful for navigation and other functions. The wireless device 30 also includes a cell phone transceiver 98 having an antenna 108 to allow cell phone transmission and reception. It should be appreciated that these and other various receivers may be employed within the wireless device 30, as opposed to being installed directly onto the vehicle 10, in accordance with the teachings of the present invention.

Also provided in wireless device is memory 82, which may include random access memory (RAM), electronically erasable programmable read-only memory (EEPROM), flash memory or other known memory storage medium. The memory 82 may store data related to both the vehicle fob functionality and the entertainment and information functionality. For example, user preferences, audio playlists, cell phone numbers, navigation data, and other information may be stored within memory 82. The information stored in memory 82 may be downloaded to the vehicle 10 using wire or wireless communications.

Wireless device 30 is shown having a USB connector 112 that allows for the interfacing with the USB connector 58 on board the vehicle 10, and docking station contacts 118 that allow the wireless device 30 to make contact with electrical contacts in the docking station 16 on board the vehicle 10. The wireless device 30 includes a rechargeable battery 114, which may be charged by way of charging circuitry 116, such as an inductive coil that communicates inductively with the charger 18 on board the vehicle 10.

The fob display 34 is shown having a touch pad 120 and other user input buttons 32 that communicate with the controller 80. Further, a Bluetooth® module 84 communicates with the controller 80 and has an antenna 86 to allow short range communication at the wireless device 30 with the VIM 20 when used inside of the vehicle 10.

Accordingly, the multi-purpose wireless device 30 advantageously eliminates the need for in-vehicle radio receivers and associated antennas, GPS receivers and antennas, cell phones, CD players, and other multi-media devices and their control functions. This simplifies the electronic architecture, reduces the cost and improves fuel economy of the vehicle 10. Additionally, the multi-purpose wireless device 30 allows for the option of purchasing a vehicle without a radio installed therein, reduces wiring and associated costs, simplifies the electronic architecture of the vehicle and reduces the number of devices that users may carry, and enables seamless enjoyment of music/news and other information between the vehicle and other locations. Further, the wireless device 30 may easily be upgraded to enhance the functionality on board the vehicle 10, allows for recharging of the vehicle fob battery which further allows for the employment of enhanced power consumption fob devices, and may be integrated with various other functions.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

1. A wireless device having integrated vehicle fob and entertainment functions, said device comprising:
a vehicle fob transponder for providing signals to a vehicle for at least one of remote keyless entry, passive entry, passive start, and immobilization functions;
an entertainment receiver providing at least audio radio reception;
a controller for controlling the vehicle fob transponder and the entertainment receiver; and
a communication link for communicating with a vehicle.

2. The device as defined in claim 1 further comprising a GPS receiver.

3. The device as defined in claim 1 further comprising a docking station connection adapted to connect to a docking station in a vehicle.

4. The device as defined in claim 1, wherein the communication link comprises a wireless communication link.

5. The device as defined in claim 1, wherein the entertainment receiver comprises an AM/FM receiver and a satellite radio receiver.

6. The device as defined in claim 1 further comprising a cell phone transceiver.

7. The device as defined in claim 1 further comprising a rechargeable battery and charging circuitry, wherein the charging circuitry is adapted to connect to a charger in a vehicle.

8. The device as defined in claim 7, wherein the charger comprises an inductive charger.

9. The device as defined in claim 1, wherein the device further comprises a display and user input controls.

10. The device as defined in claim 1, wherein the device operates as a nomadic multimedia device.

11. The device as defined in claim 1 further comprising memory for storing multimedia files, audio play lists, and user preferences.

12. A vehicle comprising:
an audio speaker system for broadcasting audio sound to one or more passengers in the vehicle;
an amplifier coupled to the speaker system;
a docking station for receiving a wireless device; and
a wireless device adapted to engage the docking station, said wireless device comprising an entertainment receiver providing at least audio signals for amplification and broadcast on the speaker system, said wireless device further providing vehicle fob functionality.

13. The vehicle as defined in claim 12, wherein the wireless device comprises a transponder for providing at least one of remote keyless entry, passive entry, passive start, and immobilization as the vehicle fob functionality.

14. The vehicle as defined in claim 12, wherein the wireless device communicates via wireless communication link with the vehicle.

15. The vehicle as defined in claim 12, wherein the entertainment receiver comprises a radio receiver.

16. The vehicle as defined in claim 12, wherein the wireless device comprises a cell phone transceiver.

17. The vehicle as defined in claim 12, wherein the wireless device comprises a rechargeable battery and charging circuitry, wherein the charging circuitry is adapted to connect to a charger in the vehicle.

18. The vehicle as defined in claim 17, wherein the charger comprises an inductive charger.

19. The vehicle as defined in claim 18, wherein the wireless device comprises a display and user input controls.

20. The vehicle as defined in claim 12, wherein the wireless device operates as a nomadic multimedia device.

21. The vehicle as defined in claim 12, wherein the wireless device comprises memory for storing multimedia files, audio play lists, and user preferences.

22. The vehicle as defined in claim 12, wherein the wireless device further controls vehicle systems including at least one of radio, HVAC, and navigation functions and displays information including the display of real-time vehicle parameters replacing the cluster functions.
